(19) United States
(12) Patent Application Publication
(10) Pub. No.: US 2013/0171067 A1
(43) Pub. Date: Jul. 4, 2013

(54) TECHNETIUM-99m COMPLEX AS A TOOL FOR THE IN VIVO DIAGNOSIS OF CANCEROUS TUMOURS

(71) Applicants: Yves Guminski, Lagarrigue (FR); Thierry Imbert, Viviers Les Montagnes (FR); Sabrina Pesnel, Olivet (FR); Nicolas Guilbaud, Toulouse (FR); Alain Le Pape, Lignieres de Touraine (FR); Stéphanie Lerondel, Orleans (FR)

(72) Inventors: Yves Guminski, Lagarrigue (FR); Thierry Imbert, Viviers Les Montagnes (FR); Sabrina Pesnel, Olivet (FR); Nicolas Guilbaud, Toulouse (FR); Alain Le Pape, Lignieres de Touraine (FR); Stéphanie Lerondel, Orleans (FR)

(73) Assignee: PIERRE FABRE MEDICAMENT, Boulogne-Billancourt (FR)

(21) Appl. No.: 13/823,891

(22) PCT Filed: Nov. 24, 2011
(86) PCT No.: PCT/EP11/70981

§ 371 Date: Mar. 15, 2013

(30) Foreign Application Priority Data
Nov. 24, 2010 (FR) 1059690

(51) Int. Cl. C07F 13/00

(52) U.S. Cl. CPC C07F 13/005
USPC 424/1.65; 546/306; 534/14; 435/29

(57) ABSTRACT

The invention relates to a compound having formula (I), compositions containing same and preparation methods thereof. The invention also relates to a complex of the compound having formula (I) with technetium-99m and tricine, the use of this complex as a diagnostic probe, diagnostic compositions containing same and methods for preparing the complex and compositions containing same.

The present invention relates to radiopharmaceutical derivatives consisting of polyamines conjugated with HYNIC (hydrazinonicotinamide) suitable for complexing Technetium-99m, the process for preparing same and use thereof in the form of imaging agents for detecting the polyamine transport system in cancerous cells to enable the selection of patients having such tumours with a view to adapting their treatment.

The major potential offered by tracer and radioactivity applications in the biological field and in medicine has been one of the essential factors in medical progress in the 20th Century. Techniques using radioactivity broaden the diagnostic possibilities for detecting and curing diseases: the field of nuclear medicine. Instead of applying radiation throughout the entire body as in radiography, a small amount of molecules labelled with a radio-isotope emitting gamma radiation is introduced into the body. This tracer will recognise certain targets of interest which will be subsequently detected with a γ-camera.

Cancer continues to be one of the main causes of mortality in the Western world. In many cases, control means such as prevention, surgery, radiotherapy, immunotherapy and chemotherapy still do not allow eradicating the disease in many cases. The reasons for this failure are partly due to the difficulty identifying the tumour cell and treating the cell selectively without causing excessive damage to healthy tissue.

In vivo scintigraphy imaging is a tool for identifying tumour tissue in relation to healthy tissue. This radioactive labelling approach is capable of detecting extremely small tumours. It is based on obtaining a tissue map in vivo using the external detection of the gamma radiation emitted by radio-isotopes during the disintegration thereof in tissues, generating a 3D image.

The ideal radio-isotope for SPECT (Single-Photon Emission Computer Tomography) imaging is ^{99m}Tc, due to the low cost thereof per dose and the availability thereof using generator systems available in hospital environments. More than 80% of all the diagnostic nuclear medicine imaging studies worldwide are performed using this radio-isotope (^{99m}Tc). This radioactive element emits γ radiation which is particularly suitable for medical imaging and the extensive use thereof for medical diagnostics. The γ radiation emitted by the isotope is detected in vivo using a gamma-camera for forming scintigraphic images.

Technetium-99m is of particular interest for medical applications: the radiation emitted by the disintegration of this isotope has the same wavelength as the X-rays used in conventional radiography, giving same a suitable penetration length while causing minimal damage for a gamma photon. Furthermore, the very short half-life of this isotope combined with the relatively long half-life of the daughter isotope Tc-99 enables the elimination thereof from the body before further disintegration. The half-life thereof is 6 hours, which gives sufficient time for image acquisition and enables rapid elimination of the radioactivity. This enables nuclear diagnostics in exchange for introducing a relatively low dose of radiation into the body.

Furthermore, it is readily available in hospitals by means of a technetium generator. The generator contains radioactive molybdenum 99, attached (absorbed) to an alumina column. Molybdenum is disintegrated to produce ^{99m}Tc, which is recovered by rinsing the column in a physiological solution in the form of sodium pertechnetate (Na⁺TcO₄⁻.

Technetium-99m may be used in a simple molecular form (^{99m}Tc-Pertechnetate) but is more frequently associated with molecules giving same particular properties. For example, Technetium-99m complexed with diethylenetriaminepentacetic acid (^{99m}Tc-DTPA) eliminated exclusively by glomerular filtration is a good marker of kidney function. Technetium-99m associated with methyldiphosphonate (^{99m}Tc-MDP) has a particular affinity for bone tissue. This radiopharmaceutical compound is used for detecting zones of osteoblast activity. The radiation intensity makes it possible to determine the concentration of radiopharmaceutical compound in the biological fluid or the organ under study.

The compounds complexed with Technetium-99m also include H.M.P.A.O. (hexa-methyl-propylene-amine-oxime) which is used to study strokes, partial epilepsy, some forms of dementia and cerebral distress in infants; sesta-M.I.B.I. (methoxy-iso-butyl-isonitrile) used for diagnosing myocardial ischemia (stoppage or lack of blood and oxygen supply to the heart). Technetium-99m may also be complexed with red blood cells for studying cardiac ventricular contraction, and with albumin microparticles, used to study lung vascularisation, particularly in the diagnosis of embolism. Mention may also be made of DMSA (di-mercaptosuccinic acid); DTPA (diethylene-triamino-pentacetic acid) or M.A.G.3 (mercapto-acetyl-tri-glycine) used for the separate functional evaluation of each kidney in numerous kidney conditions, preoperative evaluation for kidney ablation and congenital renal malformation exploration; IDA (imino-diacetic acid) used to view the bile ducts in digestive surgery; labelled colloids for studying the lymphatic pathway and lymph nodes and sentinel node (first lymph node affected by tumour extension) detection. Finally, foods labelled with Technetium-99m are used to study digestive transit (oesophagus, stomach, or small and large intestine).

Technetium-99m is also frequently used in double-label scintigraphy, used, by means of image subtraction, for studying an organ with no specific tracer. In this way, the parathyroid glands are visualised by comparing images obtained using thallium 201, which binds with the thyroid and parathyroids, to those obtained using Technetium-99m, which only binds with the thyroid.

However, there remains a need to determine the precise location and/or the response capacity of a cell to a particular cytotoxic agent. In this instance, interest is focussed on tumour cells or tumours over-expressing the polyamine transport system (PTS). Indeed, at the present time, there is no means for determining, quickly and non-invasively, whether a tumour will respond to a treatment targeting the PTS system or not.

The present invention thus addresses this problem.

The present invention thus relates to polyamines conjugated with hydrazinonicotinamide or HYNIC polyamines having the following formula (I):

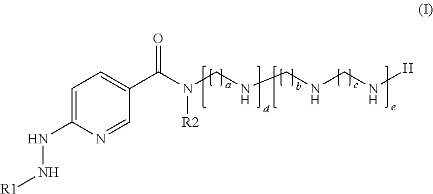

wherein:
R1 represents a hydrogen atom or an N-protecting group such as a tert-butyloxycarbonyl (tBuOCO) or trifluoroacetyl (CF₃CO) group,
R2 represents a hydrogen atom, an optionally fluorinated or perfluorinated C₁₋₆alkyl group, or an amino-C₁₋₆alkyl group,
a, b and c represent, independently of each other, an integer from 2 to 5, and
d and e represent, independently of one another, 0, 1 or 2, on the condition that d and e are not both simultaneously equal to 0,
   or a pharmaceutically acceptable salt thereof.

The term “protecting group” or “protection group” refers, according to the present invention, to a group selectively blocking a reactive site in a multifunctional compound such that a chemical reaction can be performed selectively on another non-protected reactive site in the sense conventionally associated therewith in chemical synthesis.

The term “N-protecting group” refers, according to the present invention, to any substituent protecting the NH or NH₂ group against undesirable reactions such as the N-protecting groups described in Greene, “Protective Groups In Organic synthesis”, (John Wiley & Sons, New York (1981)) and Harrison et al. “Compendium of Synthetic Organic Methods”, Vols. 1 to 8 (J. Wiley & sons, 1971 to 1996). N-protecting groups comprise carbamates, amides, N-alkylated derivatives, aminoacetal derivatives, N-benzylated derivatives, imine derivatives, enamine derivatives and N-heteroatom derivatives. In particular, the N-protecting group comprises formyl, acetyl, trifluoroacetyl, benzoyl, pivaloyl, phenylsulfonyl, benzyl (Bn), t-butyloxycarbonyl (BOC), benzyloxycarbonyl (Z), p-methoxy-benzyloxycarbonyl, p-nitrobenzyl-oxycarbonyl, trichloroethoxycarbonyl (TROC), allyloxycarbonyl (Alloc), 9-fluorenylmethyloxycarbonyl (Fmoc), trifluoro-acetyl, benzyl carbamates (optionally substituted) and similar. It may particularly consist of a BOC, Z or trifluoroacetyl (CF₃CO) group.

The term “C₁₋₆alkyl” group refers, according to the present invention, to a linear or branched saturated hydrocarbon chain, comprising 1 to 6, preferably 1 to 4, carbon atoms. Examples include the methyl, ethyl, propyl, isopropyl, butyl, isobutyl, sec-butyl, tert-butyl, pentyl or hexyl groups.

A “fluorinated C₁₋₆alkyl” group is a C₁₋₆alkyl group as defined above for which one or more hydrogen atoms are replaced by a fluorine atom.

A “perfluorinated C₁₋₆alkyl group” is a C₁₋₆alkyl group as defined above for which all the hydrogen atoms are replaced by a fluorine atom.

The term “amino-C₁₋₆alkyl” group refers, according to the present invention, to an NH₂—C₁₋₆alkyl-group with the C₁₋₆alkyl group as defined above.

In the present invention, “pharmaceutically acceptable” refers to that which is useful for preparing a composition intended to be administered to an animal, such as a mammal, including humans, which is generally safe, non-toxic and not biologically or otherwise undesirable and which is acceptable for veterinary use and for pharmaceutical or human diagnostic use.

The term “pharmaceutically acceptable salts” of a compound refers to salts which are pharmaceutically acceptable, as defined herein, and which have the sought pharmacological or diagnostic activity of the parent compound. Such salts comprise:

(1) hydrates and solvates,

(2) pharmaceutically acceptable acid addition salts formed with pharmaceutically acceptable inorganic or organic acids, such as hydrochloric acid or hydrobromic acid, or

(3) pharmaceutically acceptable base addition salts formed when an acidic proton contained in the parent compound is either replaced by a metal ion, for example an alkaline metal ion, an alkaline-earth metal ion or an aluminium ion; or coordinated with a pharmaceutically acceptable organic or inorganic base.

Preferably, it consists of acid addition salts, such as a hydrochloric acid addition salt.

In the definition of R1, the N-protecting group will more particularly be a protecting group suitable for cleaving in an acidic medium such as a BOC or trifluoroacetyl (CF₃CO) group.

R1 represents more particularly a hydrogen atom or a tert-butyloxycarbonyl (tBuOCO) or trifluoroacetyl (CF₃CO) group.

R2 particularly represents a hydrogen atom or a C₁₋₆alkyl group such as methyl.

More particularly, a, b and c represent, independently from each other, 3 or 4.

Preferably, d and e represent 1 or 2, and advantageously 1.

According to a further embodiment of the invention, e represents 2 and d represents 0.

According to a further embodiment of the invention, e represents [GS1]1, preferably 1, and d represents 0, 1 or 2, preferably 1 or 2.

More particularly, it may consist of a compound having formula (I) wherein:
R1=R2=H, a=4, d=1 and e=0,
R1=R2=H, b=3, c=4, d=0 and e=1,
R1=R2=H, a=3, b=4, c=3, d=1 and e=1,
R1=R2=H, a=3, b=4, c=3, d=2 and e=1,
R1=CF₃CO, R2=H, a=3, b=4, c=3, d=1 and e=1,
R1=tBuOCO, R2=H, a=3, b=4, c=3, d=1 and e=1, or
R1=H, R2=CH₃, b=3, c=4, d=0 and e=1,
   or a pharmaceutically acceptable salt thereof.

Advantageously, it consists of a compound having formula I wherein:
R1=R2=H, a=3, b=4, c=3, d=1 and e 1,
R1=R2=H, a=3, b=4, c=3, d=2 and e=1,
R1=CF₃CO, R2=H, a=3, b=4, c=3, d=1 and e=1, or
R1=tBuOCO, R2=H, a=3, b=4, c=3, d=1 and e=1,
   or a pharmaceutically acceptable salt thereof.

Such compounds are not useful per se but are suitable for complexing Technetium-99m with other ligands such as tricine. The complex formed will be useful as a radio-tracer for use in scintigraphic imaging to detect cancerous tumours expressing the polyamine transport system.

The present invention thus secondly relates to a complex having the following formula (II):

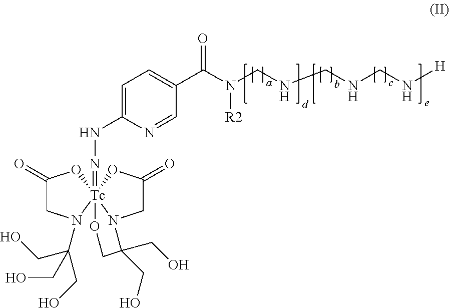

wherein technetium (Tc) is present in the form of the 99m isotope thereof and R2, a, b, c, d and e are as defined above,
or a pharmaceutically acceptable salt thereof.

R2 notably represents a hydrogen atom of a C₁₋₆alkyl group such as methyl.

More particularly, a, b and c represent, independently of each other, 3 or 4.

Preferably, d and e represent 1 or 2, and advantageously 1.

Indeed, preferably, the polyamine unit of the compounds according to the present invention comprises at least three, and advantageously three, basic nitrogens so that the compounds having formula (II) are processed by the polyamine transport system and thus that the labelling is sufficient to enable the detection of the tumours expressing this polyamine transport system.

According to a further embodiment of the invention, e represents 2 and d represents 0.

According to a further embodiment of the invention, e represents 1, preferably 1, and d represents 0, 1 or 2, preferably 1 or 2.

More particularly, it may consist of a compound having formula (II) wherein:
R2=H, a=4, d=1 and e=0,
R2=H, b=3, c=4, d=0 and e=1,
R2=H, a=3, b=4, c=3, d=1 and e=1,
R2=H, a=3, b=4, c=3, d=2 and e=1, or
R2=CH₃, b=3, c=4, d=0 and e=1,
   or a pharmaceutically acceptable salt thereof.
   Advantageously, it consists of a compound having formula II wherein:
R2=H, a=3, b=4, c=3, d=1 and e=1, or
R2=H, a=3, b=4, c=3, d=2 and e=1,
   or a pharmaceutically acceptable salt thereof.

The present invention thirdly relates to the use of a compound having formula (II) as defined above or a pharmaceutically acceptable salt thereof as a diagnostic probe for medical imaging, particularly by means of scintigraphy, more particularly for detecting a cancerous tumour expressing the polyamine transport system in vivo or in vitro, particularly in vivo.

Scintigraphy is medical imaging using compounds labelled with radioactive isotopes. These radiolabelled compounds are administered to an animal, such as a mammal, including humans, and are suitable for producing a medical image by detecting radiation emitted by the radioactive isotopes. According to the labelled compound used, it will be possible to view various parts of the body, according to the target of the labelled compound.

The present invention fourthly relates to a compound having formula (II) as defined above or a pharmaceutically acceptable salt thereof for use in the diagnosis, more particularly in vivo, of a cancerous tumour expressing the polyamine transport system, particularly by medical imaging, such as by scintigraphy.

Indeed, the Technetium-99m complex having formula (II) recognises tumour cells by exploiting the capability thereof of internalising the natural polyamines needed for the metabolism thereof.

Such as Technetium-99m complex, injected into the patient, is suitable for detecting the existence of a tumour site since the complex is preferentially distributed in the tumour.

This approach is suitable for selecting patients with a tumour clearly expressing the polyamine transport or PTS system. It is decisive in order to be able to treat said patients with an anticancer product in turn vectorised by natural polyamines, thus targeting tumour cells in relation to healthy cells. This selection of patients makes it possible to obtain a more favourable response rate, and not treat non-responder patients.

The present invention also relates to the use of a compound having formula (II) as defined above for preparing a diagnostic composition for detecting a cancerous tumour expressing the polyamine transport system, more particularly in vivo, particularly by medical imaging, such as by scintigraphy.

The present invention also relates to a method for detecting (or diagnosing) a cancerous tumour expressing the polyamine transport system comprising administration to a subject in need thereof of a sufficient quantity of a compound having formula (II) as defined above. This administration is followed by a step for detecting the radioactivity emitted by Technetium-99m, particularly by scintigraphic imaging, so as to visualise the tumour.

The present invention fifthly relates to a composition comprising at least one compound having formula (I) as defined above or a pharmaceutically acceptable salt thereof and at least one pharmaceutically acceptable excipient.

More particularly, the pharmaceutically acceptable excipient will be used in compositions administered parenterally.

These compositions particularly comprise aqueous suspensions, isotonic saline solutions or sterile solutions suitable for injection containing pharmacologically compatible dispersion agents and/or wetting agents.

The compounds having formula (I) may be present at doses between 0.01 mg and 1000 mg. The dose may be advantageously between 5 mg and 500 mg, particularly between 10 mg and 200 mg. It may be necessary to use doses outside these ranges, which would be obvious for those skilled in the art.

The present invention sixthly relates to a diagnostic composition comprising at least one compound having formula (II) according to the invention or a pharmaceutically acceptable salt thereof and at least one pharmaceutically acceptable excipient thereof.

The term “diagnostic composition” refers, according to the present invention, to a composition intended to be administered to an animal such as a mammal, including humans, with a view to conducting diagnostics, more particularly in vivo diagnostics, particularly by means of medical imaging such as by scintigraphy. Within the scope of the present invention, it would consist more particularly of enabling the detection of cancerous tumours expressing the polyamine transport system.

The technetium present in such a composition in the form of a complex having formula (II) is totally or partially (i.e. at least 80%, preferably at least 90%, more preferentially more than 90%, even more preferentially at least 95% and more preferentially again almost 100%) in 99m isotope form.

The diagnostic compositions according to the invention may be formulated for all types of sought administration, preferentially parenterally, particularly intravenously.

The active ingredient may be administered in unitary administration forms, mixed with conventional pharmaceutical substrates, to animals or humans.

For intravenous administration, aqueous suspensions, isotonic saline solutions or sterile solutions suitable for injection containing pharmacologically compatible dispersion agents and/or wetting agents will particularly be used.

The compounds according to formula (II) used as diagnostic agents may be used at doses between 5 mg and 500 mg. It may be necessary to use doses outside these ranges, which would be obvious for those skilled in the art.

Such a diagnostic composition is useful for diagnosing a cancerous tumour expressing the polyamine transport system, particularly by medical imaging, such as by scintigraphy.

The present invention seventhly relates to a process for preparing a diagnostic composition as defined above comprising the mixture of a composition comprising at least one compound having formula (I) or a pharmaceutically acceptable salt thereof as defined above with a pertechnetate-99m salt, at least one reducing agent and tricine.

The process is preferably carried out at ambient temperature, i.e. at a temperature between 15 and 40° C., particularly between 20 and 35° C., in particular at approximately 25° C.

The pertechnetate salt will preferably be an alkaline metal salt such as a sodium salt. Such a salt is more particularly used in solution in a physiological solution. Such a solution is obtained using a molybdenum 99 generator as described above.

The reducing agent may be a mixture of tin fluoride and ascorbic acid suitable for reducing Technetium from the oxidation number +VII to the number +III for the complexing thereof with the compound having formula (I) and tricine.

Tricine serves as a ligand for Technetium-99m. It complies with the following formula:

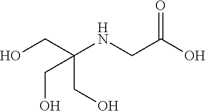 [SMILES: O=C(O)CNC(CO)(CO)CO]

For example, for 1.5 mg of compound having formula (I), 24 mg of tricine, 80 μg of tin fluoride and 0.5 mg of ascorbic acid can be used.

Such a composition is prepared extemporaneously, i.e. immediately prior to use.

The present invention thus eighthly relates to a kit comprising:
(1) a composition comprising at least one compound having formula (I) as defined above or a pharmaceutically acceptable salt thereof and at least one pharmaceutically acceptable excipient,
(2) tricine, and
(3) a reducing agent.

This kit may further comprise the instructions required for using the kit, particularly in cancerous tumour diagnostics.

The reducing agent may be a mixture of tin fluoride and ascorbic acid.

For example, for 1.5 mg of compound having formula (I) present in composition (1), the kit may contain 24 mg of tricine, 80 μg of tin fluoride and 0.5 mg of ascorbic acid.

The present invention ninthly relates to a process for preparing a compound having formula (I) as defined above or a pharmaceutically acceptable salt thereof comprising the following successive steps:
(a) reacting 6-halo-nicotinic acid with a protected polyamine having the following formula (III):

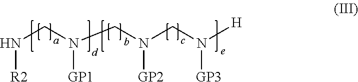

wherein R2, a, b, c, d and e are as defined above and GP1, GP2 and GP3, identical or different, each represent an N-protecting group,
to obtain a compound having the following formula (IV):

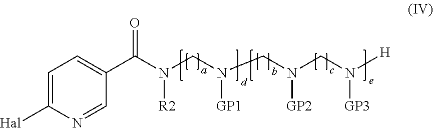

wherein R2, a, b, c, d, e, GP1, GP2 and GP3 are as defined above and Hal represents a halogen atom,
(b) reacting the compound having formula (IV) obtained in step (a) above with hydrazine to obtain a compound having the following formula (V):

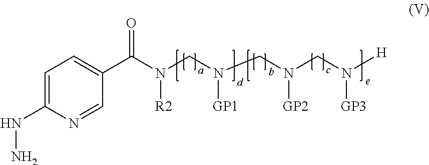

wherein R2, a, b, c, d, e, GP1, GP2 and GP3 are as defined above,
(c) optionally protecting, with an N-protecting group, the hydrazine function of the compound having formula (V) obtained in step (b) above to obtain a compound having the following formula (VI):

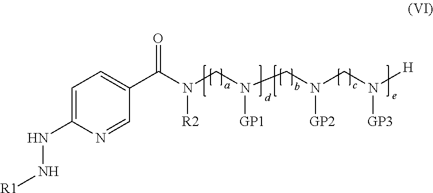

wherein R2, a, b, c, d, e, GP1, GP2 and GP3 are as defined above and R1 represents an N-protecting group as defined above,
(d) deprotecting the amine functions protected by the groups GP1, GP2 and GP3 in the compound having formula (V) or (VI) obtained in step (b) or (c) above to obtain a compound having formula (II) according to the invention,
(e) optionally salifying the compound having formula (II) obtained in step (d) above to obtain a pharmaceutically acceptable salt thereof, and
(f) separating the compound having formula (II) or the pharmaceutically acceptable salt thereof obtained in the previous step from the reaction medium.

The term “halo” or “halogen” refers, according to the present invention, to an iodine, fluorine, bromine or chlorine atom. It particularly consists of a chlorine atom.

Step (a):

The 6-halo-nicotinic acid will preferably be 6-chloro-nicotinic acid, which is a commercially available compound.

In this step, the groups GP1, GP2 and GP3 may represent a BOC or Z group. Preferably, these three protecting groups are identical.

Non-protected polyamines are commercially available and may be protected using techniques well-known to those skilled in the art enabling ready access to the compounds having formula (III). An example of a polyamine derivative, spermine protected by three BOC groups, is described in Tetrahedron Lett. 1998, 39, 439.

The amide function of the compound having formula (IV) may be formed by means of peptide coupling between the carboxylic acid function of the 6-halo-nicotinic acid and the free amine function of the protected polyamine having formula (III).

The peptide coupling may be carried out in the presence of a coupling agent, such as diisopropylcarbodiimide (DIC), dicyclohexylcarbodiimide (DCC), 1-(3-dimethylaminopropyl)-3-ethylcarbodiimide (EDC) hydrochloride, carbonyldiimidazole (CDI), 2-(1H-benzotriazole-1-yl)-1,1,3,3-tetramethyluronium hexafluorophosphate (HBTU), 2-(1H-benzotriazole-1-yl)-1,1,3,3-tetramethyluronium tetrafluoroborate (TBTU) or encore 0-(7-azobenzotriazol-1-yl)-1,1,3,3-tetramethyluronium hexafluorophosphate (HATU), optionally associated with a coupling auxiliary such as N-hydroxy succinimide (NHS), N-hydroxy benzotriazole (HOBt), 3,4-dihydro-3-hydroxy-4-oxo-1,2,3-benzotriazole (HOOBt), 1-hydroxy-7-azabenzotriazole (HAt) or N-hydroxysulfosuccinimide (sulfo NHS). In particular, the coupling may be carried out in the present of TBTU.

Moreover, the coupling may be carried out in the presence of a base such as triethylamine. An inert solvent such as acetonitrile may be used.

Step (b):

The hydrazine used will more particularly be commercially available hydrazine hydrate.

The reaction may be carried out at a high temperature, particularly by heating hydrazine to reflux, in particular at approximately 100° C.

Step (c):

This protection step may be performed using techniques well-known to those skilled in the art.

When the N-protecting group is a BOC group, it may be carried out by reacting with tert-butyl carbonate in the presence of a base such as triethylamine. Such a reaction may be carried out at ambient temperature, particularly in a solvent such as THF.

Step (d):

The deprotection step may be performed using techniques well-known to those skilled in the art.

If the protecting groups are BOC groups, deprotection may be performed in an acidic medium, particularly in the presence of hydrochloric acid or trifluoroacetic acid. Such a reaction may be performed at ambient temperature, notably in a solvent such as dioxane or isopropanol.

If the protecting groups are Z groups, deprotection may be performed by hydrogenation in a hydrogen atmosphere in the presence of a hydrogenation catalyst such as Pd/C. Such a reaction may be performed in an alcoholic medium, particularly in methanol or ethanol. Protection with Z groups is preferred if R1 represents an N-protecting group suitable for cleaving in an acidic medium. Indeed, this will make it possible to deprotect the groups GP1, GP2 and GP3 without deprotecting the group R1.

Step (e):

This step may be performed by reacting the compound having formula (II) obtained in step (d) with a pharmaceutically acceptable acid or base. It preferably consists of a pharmaceutically acceptable acid such as hydrochloric acid.

According to the nature of the protective groups GP1, GP2 and GP3 and the pharmaceutically acceptable salt sought (and particularly when GP1=GP2=GP3=BOC and the salt is a hydrochloride), it may be envisaged to perform steps (d) and (e) in a “one-pot” manner, i.e. in the same reactor, without isolating the synthesis intermediate between the two steps, and particularly using the same reagents (namely the same acid for deprotecting the groups GP1, GP2 and GP3 and for forming the pharmaceutically acceptable salt).

Step (f):

The compound obtained may be separated from the reaction medium by methods well-known to those skilled in the art, such as for example by extraction, solvent evaporation or by precipitation and filtration.

Moreover, the compound may be purified if required using techniques well-known to those skilled in the art, such as by recrystallisation if the compound is crystalline, by distillation, by silica gel column chromatography or by high-performance liquid chromatography (HPLC).

The present invention ninthly relates to a process for preparing a compound having formula (I) as defined above wherein R1≠H or a pharmaceutically acceptable salt thereof comprising the following successive steps:
(i) protecting, with an N-protecting group, the hydrazine function of 6-hydrazinyl-nicotinic acid to obtain a compound having the following formula (VII):

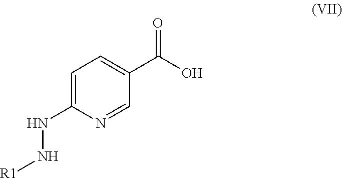

wherein R1 represents an N-protecting group as defined above,
(ii) reacting a compound having formula (VII) obtained in step (i) above with a protected polyamine having formula (III) as defined above to obtain a compound having formula (VI) as defined above,
(iii) deprotecting the amine functions protected by the groups GP1, GP2 and GP3 in the compound having formula (VI) obtained in step (ii) above to obtain a compound having formula (II) according to the invention wherein R1 # H,
(iv) optionally salifying the compound having formula (II) obtained in step (iii) above to obtain a pharmaceutically acceptable salt thereof, and
(v) separating the compound having formula (II) or the pharmaceutically acceptable salt thereof obtained in the previous step from the reaction medium.

Step (i):

6-hydrazinyl-nicotinic acid complies with the following formula:

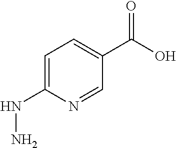 [SMILES: NNc1ccc(C(=O)O)cn1]

It may be obtained by reacting a 6-halo-nicotinic acid, such as 6-chloro-nicotinic acid, with hydrazine, and more particularly hydrazine hydrate. Such a reaction may be performed at a high temperature, particularly by heating hydrazine to reflux, in particular at approximately 100° C.

The reaction for protecting the hydrazine function with an N-protecting group is performed using methods well-known to those skilled in the art, notably using any of the methods described in step (c) above.

If the protecting group is trifluoroacetyl, the protection reaction may be performed in the presence of trifluoroacetic acid chloride or by protecting with a Boc group (see step (c)) particularly as described in J. Med. Chem. 2007, 50, 1418-1422.

Step (ii):

This step may be performed under the same conditions as those for step (a) described above.

Step (iii): see step (d) above.

Step (iv): see step (e) above.

Step (v): see step (f) above.

The present invention tenthly relates to a process for preparing a compound having formula (II) as defined above or a pharmaceutically acceptable salt thereof comprising the mixture of a compound having formula (I) as defined above or a pharmaceutically acceptable salt thereof with a pertechnetate-99m salt, at least one reducing agent and tricine.

The process is preferably carried out at ambient temperature, i.e. at a temperature between 15 and 40° C., particularly between 20 and 35° C., in particular at approximately 25° C.

This process is advantageously carried out in an aqueous medium, notably a pharmaceutically acceptable aqueous medium.

The pertechnetate salt will preferably be an alkaline metal salt such as a sodium salt.

The reducing agent may be a mixture of tin fluoride and ascorbic acid suitable for reducing Technetium from the oxidation number +VII to the number +III for the complexing thereof with the compound having formula (I) and tricine.

Tricine serves as a ligand for Technetium-99m. It complies with the following formula:

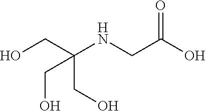 [SMILES: O=C(O)CNC(CO)(CO)CO]

For example, for 1.5 mg of compound having formula (I), 24 mg of tricine, 80 μg of tin fluoride and 0.5 mg of ascorbic acid can be used.

The present invention will be understood more clearly in the light of the non-limiting examples hereinafter.

### FIGURES

FIG. 1 represents the percentage of incorporation of a complex having formula (II) in B16/F10 and A549 cells incubated with various concentrations of complex having formula (II) and spermine.

FIG. 2 represents the SPECT image of a mouse treated according to example 301).

FIGS. 3a and 3b represent SPECT images of a mouse treated according to example 31 with a compound having formula (II) wherein R2=H, a=3, b=4, c=3, d=e=1 obtained from a compound having formula (I) wherein R1=H or CF₃CO respectively.

### EXAMPLES

### Example 1

### Preparation of {4-[(6-chloro-pyridine-3-carbonyl)-amino]-butyl}-carbamic acid tert-butyl ester

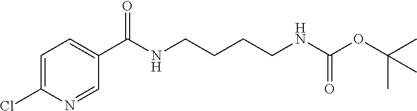 [SMILES: CC(C)(C)OC(=O)NCCCCNC(=O)c1ccc(Cl)nc1]

To the mixture of 2 g of 6-chloronicotinic acid and 2.4 g of N—BOC-1,4-diaminobutane in solution in 100 mL of acetonitrile at ambient temperature under stirring and in the presence of 2.1 mL of triethylamine, 4.1 g of TBTU is added in one go. The mixture is left to stand at this temperature for approximately 5 hours. The reaction medium is hydrolysed with 300 mL of aqueous 0.5 M hydrochloric acid solution and extracted with ethyl acetate (3×100 mL). After settling, drying on anhydrous sodium sulphate and filtration, the solvent is evaporated at reduced pressure. The residue obtained is purified by SiO₂ flash chromatography with a gradient ranging from 100% of CH₂Cl₂ to the CH₂Cl₂/Methanol/NH₄OH mixture (80/18/2) to obtain 2.1 g of cream-coloured solid after evaporating the fractions in question. (Yd: 50%).

SiO₂ TLC: CH₂Cl₂/Methanol/NH₄OH (90/9/1). Rf: 0.63.

### Example 2

### Preparation of {4-[(6-hydrazino-pyridine-3-carbonyl)-amino]-butyl}-carbamic acid tert-butyl ester

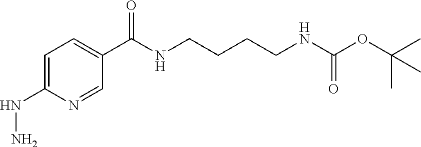 [SMILES: CC(C)(C)OC(=O)NCCCCNC(=O)c1ccc(NN)nc1]

To 2.1 g of {4-[(6-chloro-pyridine-3-carbonyl)-amino]-butyl}-carbamic acid tert-butyl ester, 30 mL of hydrazine hydrate is added. The mixture obtained is heated to reflux for approximately 5 hours. After hydrolysis in 300 mL of water, the medium is extracted with ethyl acetate (3×100 mL). The organic phases are washed with a saturated NaCl solution, and dried on anhydrous sodium sulphate. After filtration, the solvent is evaporated at reduced pressure. The residue obtained is purified by SiO₂ flash chromatography with a gradient ranging from 100% CH₂Cl₂ to 80/20 CH₂Cl₂/methanol. Further purification by means of preparative HPLC on a Waters Sunfire C18 OBD 10μ, 19×250 mm column, was performed with a gradient ranging from 5 mmol HCl to 50/50 acetonitrile/5 mmol HCl as the mobile phase, to obtain after freeze-drying the fractions in question 210 mg of the compound in the hydrochloride form thereof obtained in white powder form. (Yd: 10%).

C₁₅H₂₅N₅O₃: 323.398

HPLC analysis on Waters X-Bridge C18, 5μ, 4.6×250 mm column

Elution: Acetonitrile/pH 4 6.8 g/L KH₂PO₄ buffer (2/98), flow rate 1 mL/minute,

λ: 220 nm. Retention time: 3.43 min.

### Example 3

### Preparation of {N-(4-Amino-butyl)-6-hydrazino-nicotinamide, compound having formula (I) (R1=R2=H, a=4, d=1, e=0)

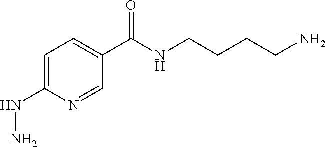 [SMILES: NCCCCNC(=O)c1ccc(NN)nc1]

0.21 g of {4-[(6-hydrazino-pyridine-3-carbonyl)-amino]-butyl}-carbamic acid tert-butyl ester hydrochloride is dissolved in 10 mL of 4M hydrochloric acid in dioxane. The reaction medium obtained is left under stirring for 6 hours at ambient temperature. The resulting precipitate is vacuum-filtered, rinsed with ethyl ether and vacuum-dried. Purification by means of preparative HPLC on a Waters Sunfire C18 OBD 10μ, 19×250 mm column was performed using a gradient ranging from 5 mmol HCl to 50/50 acetonitrile/5 mmol HCl as the mobile phase to obtain after freeze-drying the fractions in question 55 mg of the hydrochloride of the compound in the form of cream-coloured powder. (Yd: 28%).

MP: 275° C.

HPLC analysis on Waters Atlantis HILIC, 5μ4.6×150 mm column

Elution: 750/250/0.63 g Acetonitrile/water/ammonium formiate pH 5, flow rate 1 mL/minute,

λ: 220 nm. Retention time: 14.64 min.

C₁₀H₁₇N₅O: 223.28; Hydrochloride: C₁₀H₁₇N₅O, 2HCl: 296.200-Mass (ESI+400° C.): 224.2 (M+H)

¹H-NMR (400 MHz, DMSO-d6) δ=8.57 (1H, s, H-2 Ar), 8.13 (1H, d, j=8.8 Hz, H-4 Ar), 6.94 (1H, d, j=8.8 Hz, H-5 Ar), 3.28 (2H, m, CH₂NHCO), 2.82 (2H, m, CH₂NH₂), 2.54 (4H, m, CH2-CH2).

### Example 4

### Preparation of [4-(benzyloxycarbonyl-{3-[(6-chloro-pyridine-3-carbonyl)-amino]-propyl}-amino)-butyl]-carbamic acid benzyl ester

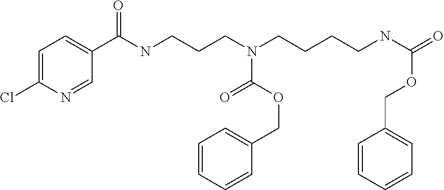 [SMILES: O=C(NCCCCN(CCCNC(=O)c1ccc(Cl)nc1)C(=O)OCc1ccccc1)OCc1ccccc1]

To the mixture of 0.23 g of 6-chloronicotinic acid and 0.77 g of {4-[(3-amino-propyl)-benzyloxycarbonyl-amino]-butyl}-carbamic acid benzyl ester (J. Med. Chem. 1997, 40, 3842-3850) in solution in 30 mL of acetonitrile at ambient temperature under stirring and in the presence of 0.3 mL of triethylamine, 0.6 g of TBTU is added in one go. The mixture is left to stand at this temperature for approximately 6 hours. The reaction medium is hydrolysed with 200 mL of aqueous 0.5 M hydrochloric acid solution and extracted with ethyl acetate (3×10 mL). After settling, drying on anhydrous sodium sulphate and filtration, the solvent is evaporated at reduced pressure. The residue obtained is purified by SiO₂ flash chromatography with a gradient ranging from 100% CH₂Cl₂ to the CH₂Cl₂/Methanol (97/3) mixture to obtain 0.52 g of colourless oil after evaporating the fractions in question. (Yd: 50%).

SiO₂ TLC: CH₂Cl₂/Methanol (95/5)-Rf: 0.44

### Example 5

### Preparation of [4-(benzyloxycarbonyl-{3-[(6-hydrazino-pyridine-3-carbonyl)-amino]-propyl}-amino)-butyl]-carbamic acid benzyl ester

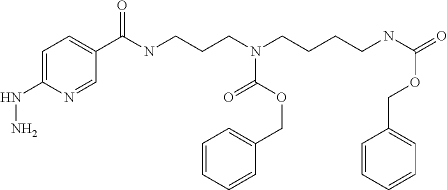 [SMILES: NNc1ccc(C(=O)NCCCN(CCCCNC(=O)OCc2ccccc2)C(=O)OCc2ccccc2)cn1]

To 0.52 g of [4-(benzyloxycarbonyl-{3-[(6-chloro-pyridine-3-carbonyl)-amino]-propyl}-amino)-butyl]-carbamic acid benzyl ester, 20 mL of hydrazine hydrate is added. The mixture obtained is heated to reflux for approximately 7 hours. After hydrolysis in 300 mL of water, the medium is extracted with ethyl acetate (3×100 mL). The organic phases are washed with a saturated NaCl solution and dried on anhydrous sodium sulphate. After filtration, the solvent is evaporated at reduced pressure. The residue obtained is purified by SiO₂ flash chromatography with a 97/3 CH₂Cl₂/methanol mixture. The fractions in question are evaporated at reduced pressure to obtain 350 mg of the compound in the form of yellow oil. (Yd: 68%).

SiO₂ TLC: CH₂Cl₂/Methanol/NH₄OH (90/10/1)-Rf: 0.41

C₂₉H₃₆N₆O₅: 548.647

### Example 6

### Preparation of N-[3-(4-amino-butylamino)-propyl]-6-hydrazino-nicotinamide, compound having formula 1(I) (R1=R2=H, d=0, b=3, c=4, e=1)

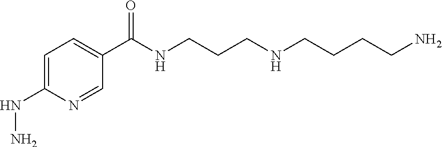 [SMILES: NCCCCNCCCNC(=O)c1ccc(NN)nc1]

0.35 g of [4-(benzyloxycarbonyl-{3-[(6-hydrazino-pyridine-3-carbonyl)-amino]-propyl}-amino)-butyl]-carbamic acid benzyl ester in solution in 20 mL of methanol in the presence of Pd/10% is stirred vigorously in a hydrogen atmosphere at ambient temperature for 5 hours. The catalyst is vacuum-filtered and rinsed with methanol. The filtrate is evaporated at reduced pressure to obtain an oily residue. The tetra-hydrochloride is precipitated by adding 4 equivalents of a 4 M hydrochloric acid solution in dioxane to a solution of the residue obtained in ethyl ether. The orange precipitate is filtered, rinsed with ethyl ether and vacuum-dried to obtain 145 mg of salt. (Yd: 53%)

MP: 183° C.

C₁₃H₂₄N₆O: 280.376; salt C₁₃H₂₄N₆O, 4HCl: 426.220-Mass 5ESI+400° C.): 281.2 (M+H).

MP: 183° C.

¹H-NMR (400 MHz, DMSO-d6) δ=8.64 (1H, s, H-2 Ar), 8.17 (1H, d, j=8.8 Hz, H-4 Ar), 6.95 (1H, d, j=8.8 Hz, H-5 Ar), 3.33 (2H, m, CH₂NHCO), 2.91 (4H, m, CH₂NH₂), 2.80 (2H, m, CH2-NH2), 1.66-1.90 (6H, m, H2C—CH2).

### Example 7

### Preparation of (3-tert-butoxycarbonylamino-propyl)-[4-(tert-butoxycarbonyl-{3-[(6-chloro-pyridine-3-carbonyl)-amino]-propyl}-amino)-butyl]-carbamic acid tert-butyl ester

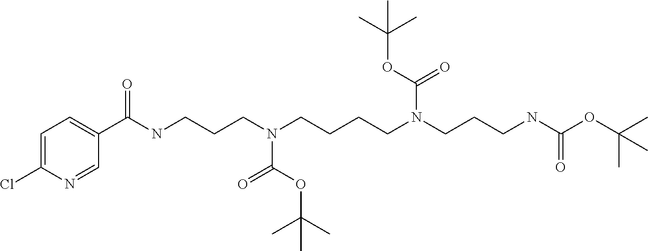 [SMILES: CC(C)(C)OC(=O)NCCCN(CCCCN(CCCNC(=O)c1ccc(Cl)nc1)C(=O)OC(C)(C)C)C(=O)OC(C)(C)C]

To the mixture of 0.31 g of 6-chloronicotinic acid and 1 g of Tri-BOC-spermine

(according to FR 2919287) in solution in 40 mL of acetonitrile at ambient temperature under stirring and in the presence of 0.3 L of triethylamine, 0.4 g of TBTU is added in one go. The mixture is left to stand at this temperature for approximately ½ hour. The reaction medium is hydrolysed with 100 mL of aqueous 0.5 M hydrochloric acid solution and extracted with ethyl acetate (3×50 mL). After settling, drying on anhydrous sodium sulphate and filtration, the solvent is evaporated at reduced pressure. The residue obtained is purified by SiO₂ flash chromatography with a gradient ranging from 100% heptane to 100% ethyl acetate to obtain 0.79 g of colourless oil after evaporating the fractions in question. (Yd: 62%).

SiO₂ TLC: CH₂Cl₂/Methanol/NH₄OH (90/9/1). Rf: 0.56

### Example 8

### Preparation of (3-tert-butoxycarbonylamino-propyl)-[4-(tert-butoxycarbonyl-{3-[(6-hydrazino-pyridine-3-carbonyl)-amino]-propyl}-amino)-butyl]-carbamic acid tert-butyl ester

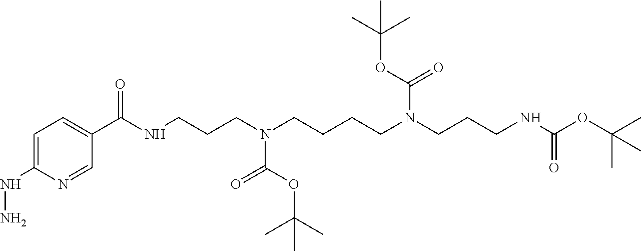 [SMILES: CC(C)(C)OC(=O)NCCCN(CCCCN(CCCNC(=O)c1ccc(NN)nc1)C(=O)OC(C)(C)C)C(=O)OC(C)(C)C]

To 0.79 g of (3-tert-butoxycarbonylamino-propyl)-[4-(tert-butoxycarbonyl-{3-[(6-chloro-pyridine-3-carbonyl)-amino]-propyl}-amino)-butyl]-carbamic acid tert-butyl ester, 30 mL of hydrazine hydrate is added. The mixture obtained is heated to reflux for approximately 6 hours. After hydrolysis in 500 mL of water, the medium is extracted with ethyl acetate (3×100 mL). The organic phases are washed with a saturated NaCl solution and dried on anhydrous sodium sulphate. After filtration, the solvent is evaporated at reduced pressure to obtain 0.74 g of greenish oily residue. (Yd: 94%).

SiO₂ TLC: CH₂Cl₂/methanol/NH₄OH (90/9/1). Rf: 0.46.

C₃₁H₅₅N₇O₇: 637.827 Mass (ESI+400° C.): 638.4 (M+H).

### Example 9

### Preparation of N-{3-[4-(3-amino-propylamino)-butyl amino]propyl}-6-hydrazino-nicotinamide, compound having formula (I) (R1=R2=H, a=3, b=4, c=3, d=e=1)

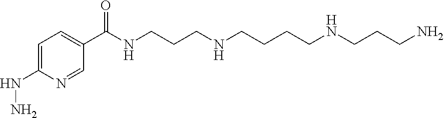 [SMILES: NCCCNCCCCNCCCNC(=O)c1ccc(NN)nc1]

0.74 g of (3-tert-butoxycarbonylamino-propyl)-[4-(tert-butoxycarbonyl-{3-[(6-hydrazino-pyridine-3-carbonyl)-amino]-propyl}-amino)-butyl]-carbamic acid tert-butyl ester is dissolved in 20 mL of 4 M hydrochloric acid in dioxane. The reaction medium is left under stirring for 7 hours at ambient temperature. The resulting precipitate is vacuum-filtered, rinsed with ethyl ether and vacuum-dried to obtain 0.45 g of cream-coloured solid. (Yd: 87%).

MP: 282° C.

SiO₂ TLC: CH₂Cl₂/methanol/NH₄OH (40/40/20). Rf: 0.16.

C₁₆H₃₁N₇O: 337.472, salt C₁₆H₃₁N₇O, 4HCl: 483.332-Mass: 338.2 (M+H) ESI+400° C.

HPLC analysis on Waters Atlantis HILIC, 5μ, 4.6×150 mm column

Elution: 700/300/0.63 g Acetonitrile/water/ammonium formiate pH 2.5, flow rate 1 mL/minute,

λ: 220 nm. Retention time: 11.35 min.

¹H-NMR (400 MHz, DMSO-d6) δ=8.64 (1H, s, H-2 Ar), 8.16 (1H, d, j=8.8 Hz, H-4 Ar), 6.94 (1H, d, j=8.8 Hz, H-5 Ar), 3.34 (2H, m, CH₂NHCO), 2.93 (8H, m, CH₂NH₂), 1.98 (4H, m, CH2), 1.88 (4H, m, H2C—CH2).

### Example 10

### Preparation of [3-(tert-butoxycarbonyl-{4-[tert-butoxycarbonyl-(3-tert-butoxycarbonyl amino-propyl)-amino]-butyl}-amino)-propyl]-{3-[(6-chloro-pyridine-3-carbonyl)-amino]-propyl}-carbamic acid tert-butyl ester

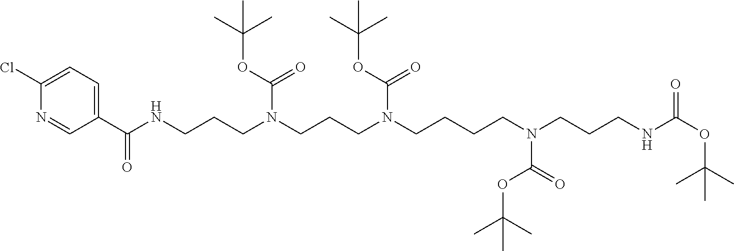 [SMILES: CC(C)(C)OC(=O)NCCCN(CCCCN(CCCN(CCCNC(=O)c1ccc(Cl)nc1)C(=O)OC(C)(C)C)C(=O)OC(C)(C)C)C(=O)OC(C)(C)C]

To the mixture of 0.21 g of 6-chloronicotinic acid and 0.88 g of (N1,N4,N9,N13-tetra-tert-butoxycarbonyl)-1,16-diamino-4,9,13-triazahexadecane (Tetrahedron 2000, 56 2449-2460) in solution in 100 mL of acetonitrile at ambient temperature under stirring and in the presence of 0.22 mL of triethylamine, 0.43 g of TBTU is added in one go. The mixture is left to stand at this temperature for approximately 5 hours. The reaction medium is hydrolysed with 100 mL of aqueous 0.5 M hydrochloric acid solution and extracted with ethyl acetate (3×50 mL). After settling, drying on anhydrous sodium sulphate and filtration, the solvent is evaporated at reduced pressure. The residue obtained is purified by SiO₂ flash chromatography with a gradient ranging from 100% CH₂Cl₂ to the CH₂Cl₂/Methanol/NH₄OH (80/18/2) mixture to obtain 0.66 g of colourless oil after evaporating the fractions in question. (Yd: 62%).

SiO₂ TLC: CH₂Cl₂/Methanol/NH₄OH (90/9/1). Rf: 0.53.

### Example 11

### Preparation of [3-(tert-butoxycarbonyl-{4-[tert-butoxycarbonyl-(3-tert-butoxycarbonyl amino-propyl)-amino]-butyl}-amino)-propyl]-{3-[(6-hydrazino-pyridine-3-carbonyl)-amino]-propyl}-carbamic acid tert-butyl ester

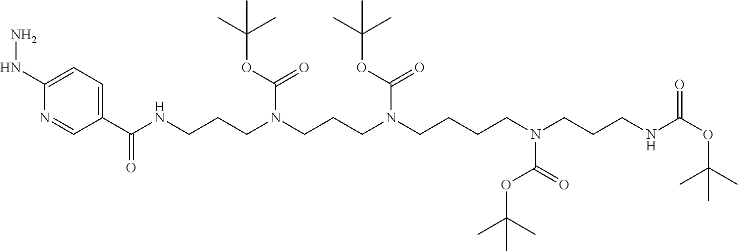 [SMILES: CC(C)(C)OC(=O)NCCCN(CCCCN(CCCN(CCCNC(=O)c1ccc(NN)nc1)C(=O)OC(C)(C)C)C(=O)OC(C)(C)C)C(=O)OC(C)(C)C]

To 0.66 g of [3-(tert-butoxycarbonyl-{4-[tert-butoxycarbonyl-(3-tert-butoxycarbonyl amino-propyl)-amino]-butyl}-amino)-propyl]-{3-[(6-chloro-pyridine-3-carbonyl)-amino]-propyl}-carbamic acid tert-butyl ester, 20 mL of hydrazine hydrate is added. The mixture obtained is heated to reflux for approximately 5 hours. After hydrolysis in 300 mL of water, the medium is extracted with ethyl acetate (3×100 mL). The organic phases are washed with a saturated NaCl solution and dried on anhydrous sodium sulphate. After filtration, the solvent is evaporated at reduced pressure to obtain an oily residue which is purified by SiO₂ flash chromatography with a gradient ranging from 100% CH₂Cl₂ to the CH₂Cl₂/Methanol (80/20) to obtain 0.31 g of yellow oil after evaporating the fractions in question. (Yd: 47%).

SiO₂ TLC: CH₂Cl₂/methanol/NH₄OH (90/9/1). Rf: 0.28.

C₃₉H₇₀N₈O₉: 795.041

HPLC analysis on Waters X-Bridge C18, 5μ, 4.6×250 mm column

Elution: Acetonitrile/pH 4 6.8 g/L KH₂PO₄ buffer (50/50), flow rate 1 mL/minute,

λ: 220 nm. Retention time: 15.07 min.

### Example 12

### Preparation of N-(3-{3-[4-(3-amino-propylamino)-butylamino]-propylamino}-propyl)-6-hydrazino-nicotinamide, compound having formula (I) (R1=R2=H, a=3, b=4, c=3, d=2, e=1)

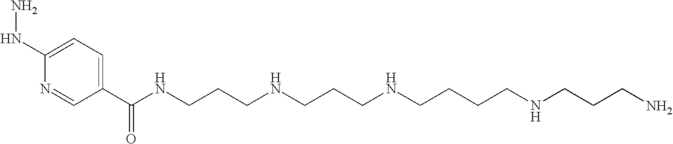 [SMILES: NCCCNCCCCNCCCNCCCNC(=O)c1ccc(NN)nc1]

0.31 g of ([3-(tert-butoxycarbonyl-{4-[tert-butoxycarbonyl-(3-tert-butoxycarbonyl-amino-propyl)-amino]-butyl}-amino)-propyl]-(3-[(6-hydrazino-pyridine-3-carbonyl)-amino]-propyl)-carbamic acid tert-butyl ester is dissolved in 10 mL of 4 M hydrochloric acid in dioxane. The reaction medium obtained is left under stirring for 6 hours at ambient temperature. The resulting precipitate is vacuum-filtered, rinsed with ethyl ether and vacuum-dried. Purification by means of preparative HPLC on a Waters Sunfire C18 OBD 10μ, 19×250 mm column was performed using a gradient ranging from 5 mmol HCl to 50/50 acetonitrile/5 mmol HCl as the mobile phase to obtain, after freeze-drying the fractions in question, 37 mg of penta-hydrochloride of the compound in grey powder form. (Yd: 16%).

MP: 307° C.

C₁₉H₃₈N₈O: 394.568, salt C₁₉H₃₈N₈O, 5HCl: 576.870-Mass (ESI+400° C.): 365.2 (M-NH—NH2).

HPLC analysis on Waters Atlantis HILIC, 5μ, 4.6×150 mm column

Elution: 650/350/0.63 g Acetonitrile/water/ammonium formiate pH 2, flow rate 1 mL/minute,

λ: 220 nm. Retention time: 7.33 min.

¹H-NMR (400 MHz, DMSO-d6) δ=8.63 (1H, s, H-2 Ar), 8.17 (1H, d, j=8.8 Hz, H-4 Ar), 6.95 (1H, d, j=8.8 Hz, H-5 Ar), 3.35 (2H, m, CH₂NHCO), 2.98 (12H, m, CH₂NH₂), 1.97 (6H, m, CH2), 1.88 (4H, m, H2C—CH2).

### Example 13

### Preparation of (3-benzyloxycarbonyl-amino-propyl)-(4-{benzyloxycarbonyl-[3-({6-[N1′-(2,2,2-trifluoro-acetyl)-hydrazino]-pyridine-3-carbonyl}-amino)-propyl]-amino}-butyl)-carbamic acid benzyl ester

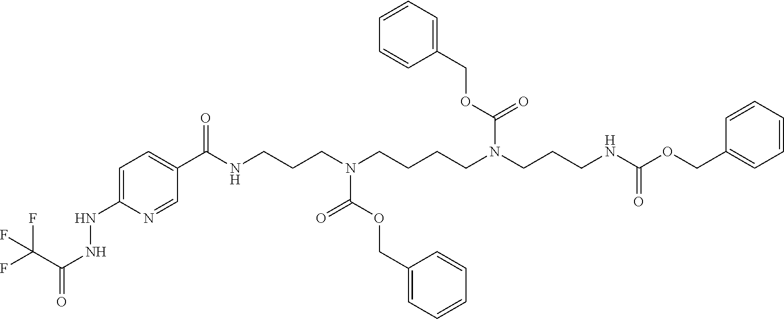 [SMILES: O=C(NCCCN(CCCCN(CCCNC(=O)c1ccc(NNC(=O)C(F)(F)F)nc1)C(=O)OCc1ccccc1)C(=O)OCc1ccccc1)OCc1ccccc1]

To the mixture of 0.49 g of 6-(2-(2,2,2-trifluoroacetyl)hydrazinyl)nicotinic acid and 1.2 g of tri-Z-spermine (Tetrahedron Letters 1998, 39, 439-442) in solution in 12 mL of DMF at ambient temperature under stirring and in the presence of 0.33 mL of triethylamine, 0.63 g of TBTU is added in one go. The mixture is left to stand at this temperature for approximately 5 hours. The reaction medium is hydrolysed with 100 mL of aqueous 0.5 M hydrochloric acid solution and extracted with ethyl acetate (3×50 mL). After settling, drying on anhydrous sodium sulphate and filtration, the solvent is evaporated at reduced pressure. The residue obtained is purified by SiO₂ flash chromatography with a gradient ranging from 100% heptane to 100% ethyl acetate to obtain 1.23 g of yellow solid. The hydrochloride is precipitated in dichloromethane by adding 1 equivalent of a 4 M hydrochloric acid solution in dioxane to obtain 0.93 g of pale yellow solid. (Yd: 56%).

SiO₂ TLC: CH₂Cl₂/Methanol/NH₄OH (90/9/1). Rf: 0.2.

HPLC analysis on Waters X-Bridge C18, 5 4.6×250 mm column

Elution: Acetonitrile/pH 4 6.8 g/L KH₂PO₄ buffer (60/40), flow rate 1 mL/minute.

λ: 220 nm. Retention time: 7.69 min.

### Example 14

### Preparation of N-{3-[4-(3-amino-propylamino)-butylamino]-propyl}-6-[N′-(2,2,2-trifluoro-acetyl)-hydrazino]-nicotinamide, compound having formula (I) (R1=CF₃CO, R2=H, a=3, b=4, c=3, d=e=1)

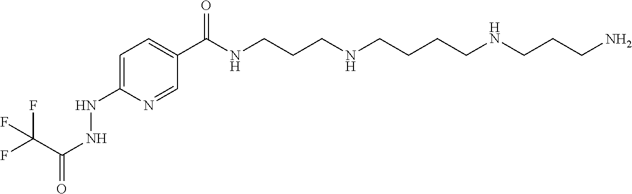 [SMILES: NCCCNCCCCNCCCNC(=O)c1ccc(NNC(=O)C(F)(F)F)nc1]

0.52 g of (3-benzyloxycarbonylamino-propyl)-(4-{benzyloxycarbonyl-[3-({6-[N′-(2,2,2-trifluoro-acetyl)-hydrazino]-pyridine-3-carbonyl}-amino)-propyl]-amino}-butyl)-carbamic acid benzyl ester in solution in 30 mL of methanol in the presence of Pd/10% is stirred vigorously in a hydrogen atmosphere at ambient temperature for 5 hours. The catalyst is vacuum-filtered and rinsed with methanol. The filtrate is evaporated at reduced pressure without heating to obtain an oily residue. The tetra-hydrochloride is precipitated by adding 4 equivalents of a 4 M hydrochloric acid solution in dioxane to a solution of the residue obtained in dichloromethane. The beige precipitate is filtered, rinsed with ethyl ether and vacuum-dried to obtain 162 mg of salt. (Yd: 40%).

MP: 237.5° C.

C₁₈H₃₀F₃N₇O₂: 433, 481, salt C₁₈H₃₀F₃N₇O₂, 4HCl: 579.341-Mass (APCI+500° C.): 434.2 (M+H)

HPLC analysis on Waters Atlantis HILIC, 5μ, 1, 4.6×150 mm column

Elution: 700/300/0.63 g Acetonitrile/water/ammonium formiate pH 2.5, flow rate 1 m L/minute,

λ: 220 nm. Retention time: 5.62 min.

¹H-NMR (400 MHz, DMSO-d6) δ=8.58 (1H, s, H-2 Ar), 7.98 (1H, d, j=8.8 Hz, H-4 Ar), 6.74 (1H, d, j=8.8 Hz, H-5 Ar), 3.34 (2H, m, CH₂NHCO), 2.95 (8H, m, CH₂NH₂), 1.95 (4H, m, CH2), 1.68 (4H, m, H2C—CH2).

### Example 15

### Preparation of (3-benzyloxycarbonylamino-propyl)-[4-(benzyloxycarbonyl-{3-[(6-chloro-pyridine-3-carbonyl)-amino]-propyl}-amino)-butyl]-carbamic acid benzyl ester

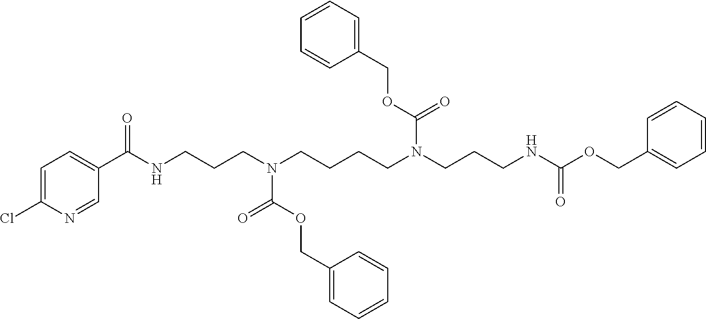 [SMILES: O=C(NCCCN(CCCCN(CCCNC(=O)c1ccc(Cl)nc1)C(=O)OCc1ccccc1)C(=O)OCc1ccccc1)OCc1ccccc1]

To the mixture of 0.98 g of 6-chloronicotinic acid and 3.74 g of tri-Z-spermine (Tetrahedron Letters 1998, 39, 439-442) in solution in 100 mL of acetonitrile at ambient temperature under stirring and in the presence of 1.05 mL of triethylamine, 2 g of TBTU is added in one go. The mixture is left to stand at this temperature for approximately 90 minutes. The reaction medium is hydrolysed with 100 mL of aqueous 0.5 M hydrochloric acid solution and extracted with ethyl acetate (3×50 mL). After settling, drying on anhydrous sodium sulphate and filtration, the solvent is evaporated at reduced pressure. The residue obtained is purified by SiO₂ flash chromatography with a gradient ranging from 100% heptane to 100% ethyl acetate to obtain 1.6 g of yellow oil. (Yd: 35%).

SiO₂ TLC: CH₂Cl₂/Methanol/NH₄OH (90/9/1). Rf: 0.45.

C₄₀H₄₆ClN₅O₇: 744.295

### Example 16

### Preparation of (3-benzyloxycarbonylamino-propyl)-[4-(benzyloxycarbonyl-{3-[(6-hydrazino-pyridine-3-carbonyl)-amino]-propyl}-amino)-butyl]-carbamic acid benzyl ester

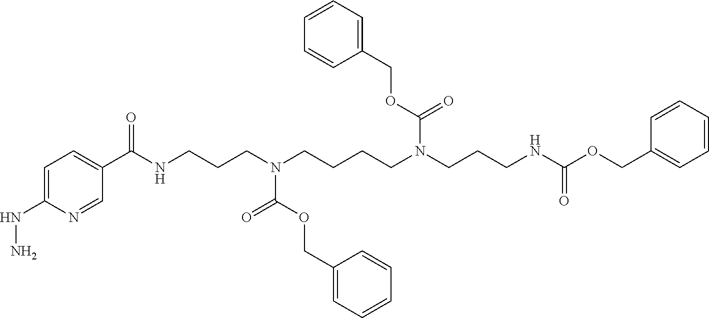 [SMILES: NNc1ccc(C(=O)NCCCN(CCCCN(CCCNC(=O)OCc2ccccc2)C(=O)OCc2ccccc2)C(=O)OCc2ccccc2)cn1]

To 1.6 g of (3-benzyloxycarbonylamino-propyl)-[4-(benzyloxycarbonyl-{3-[(6-chloro-pyridine-3-carbonyl)-amino]-propyl}-amino)-butyl]-carbamic acid benzyl ester, 20 mL of hydrazine hydrate is added. The mixture obtained is heated to reflux for approximately 2 hours. After hydrolysis in 300 mL of water, the medium is extracted with ethyl acetate (3×100 mL). The organic phases are washed with a saturated NaCl solution and dried on anhydrous sodium sulphate. After filtration, the solvent is evaporated at reduced pressure to obtain 1.8 g of oily residue. (Yd: quantitative).

SiO₂ TLC: CH₂Cl₂/methanol/NH₄OH (90/9/1). Rf: 0.40.

C₄₀H₄₉N₇O₇: 739.879 Mass (ESI+400° C.): 740.5 (M+H)

### Example 17

### Preparation of N′-{5-[3-(benzyloxycarbonyl-{4-[benzyloxycarbonyl-(3-benzyloxycarbonylamino-propyl)-amino]-butyl}-amino)-propylcarbamoyl]-pyridin-2-yl}-hydrazine carboxylic acid tert-butyl ester

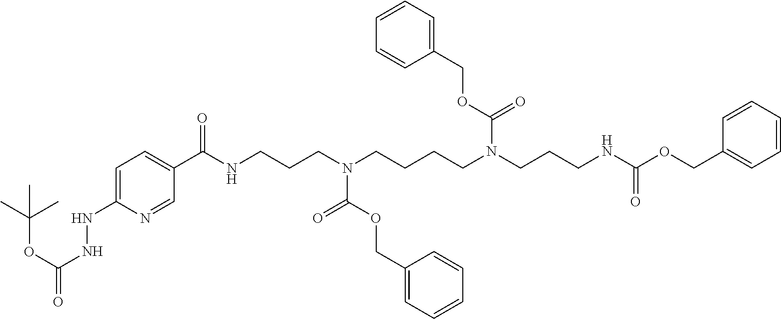 [SMILES: CC(C)(C)OC(=O)NNc1ccc(C(=O)NCCCN(CCCCN(CCCNC(=O)OCc2ccccc2)C(=O)OCc2ccccc2)C(=O)OCc2ccccc2)cn1]

To 1.6 g of (3-benzyloxycarbonylamino-propyl)-[4-(benzyloxycarbonyl-{3-[(6-hydrazino-pyridine-3-carbonyl)-amino]-propyl}-amino)-butyl]-carbamic acid benzyl ester in solution in 30 mL of THF in the presence of 2 mL of triethylamine, a solution of 2 g of di-tert-butyl carbonate in 10 mL of THF is added at ambient temperature and drop by drop. At the end of addition, the reaction medium is left for 2 hours under stirring. After hydrolysis in 300 mL of water, the medium is extracted with ethyl acetate (3×100 mL). The organic phases are washed with a saturated NaCl solution and dried on anhydrous sodium sulphate. After filtration, the solvent is evaporated at reduced pressure to obtain an oily residue which is purified by means of 5′O₂ flash chromatography with a gradient ranging from 100% heptane to 100% ethyl acetate to obtain 1.15 g of colourless oil. (Yd: 63%).

C₄₅H₅₇ClN₇O₉: 839.997

HPLC analysis on Waters X-Bridge C18, 5μ, 4.6×250 mm column

Elution: Acetonitrile/pH 4 6.8 g/L KH₂PO₄ buffer (60/40), flow rate 1 mL/minute.

λ: 220 nm. Retention time: 9.33 min.

### Example 18

### Preparation of N′-(5-{3-[4-(3-amino-propylamino)-butylamino]-propylcarbamoyl}-pyridin-2-yl)-hydrazine carboxylic acid tert-butyl ester, compound having formula (I) (R1=BOC, R2=H, a=3, b=4, c=3, d=e=1)

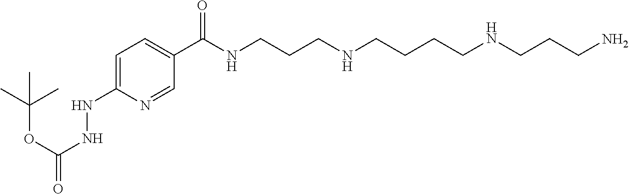 [SMILES: CC(C)(C)OC(=O)NNc1ccc(C(=O)NCCCNCCCCNCCCN)cn1]

0.2 g of (3-benzyloxycarbonylamino-propyl)-[4-(benzyloxycarbonyl-{3-[(6-hydrazino-pyridine-3-carbonyl)-amino]-propyl}-amino)-butyl]-carbamic acid benzyl ester in solution in 10 mL of methanol in the presence of Pd/10% is stirred vigorously in hydrogen atmosphere at ambient temperature for 2 hours. The catalyst is vacuum-filtered and rinsed with methanol. The filtrate is evaporated at reduced pressure without heating to obtain 110 mg of solid. (Yd: quantitative).

C₂₁H₃₉N₇O3₂: 437.590-Mass (ESI+400° C.): 438.3 (M+H).

HPLC analysis on Waters X-bridge C18, 5μ, 4.6×250 mm column

Elution: 90/10 Acetonitrile/pH 4 6.4 g/l KH₂PO₄ buffer, flow rate 1 mL/minute

λ: 220 nm. Retention time: 7.56 min

¹H-NMR (400 MHz, DMSO-d6) δ=8.64 (1H, s, H-2 Ar), 8.16 (1H, d, j=8.8 Hz, H-4 Ar), 6.94 (1H, d, j=8.8 Hz, H-5 Ar), 3.34 (2H, m, CH₂NHCO), 2.93 (8H, m, CH₂NH₂), 1.98 (4H, m, CH2), 1.88 (4H, m, H2C—CH2), 1.42 (9H, tert-butyl).

### Example 19

### Preparation of [4-(tert-butoxycarbonyl-{3-[(6-chloro-pyridine-3-carbonyl)-methyl-amino]-propyl}-amino)-butyl]-carbamic acid tert-butyl ester

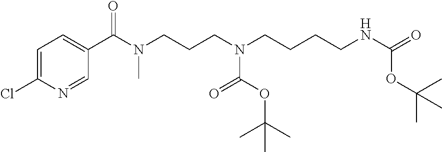 [SMILES: CN(CCCN(CCCCNC(=O)OC(C)(C)C)C(=O)OC(C)(C)C)C(=O)c1ccc(Cl)nc1]

Synthesis performed according to the [4-(benzyloxycarbonyl-{3-[(6-chloro-pyridine-3-carbonyl)-amino]-propyl}-amino)-butyl]-carbamic acid benzyl ester synthesis protocol but using the following amine: {4-[tert-butoxycarbonyl-(3-methylamino-propyl)-amino]-butyl}-carbamic acid tert-butyl ester (J. Med. Chem. 1999, 42, 277-290).

### Example 20

### Preparation of [4-(tert-butoxycarbonyl-{3-[(6-hydrazino-pyridine-3-carbonyl)-methyl-amino]-propyl}-amino)-butyl]-carbamic acid tert-butyl ester

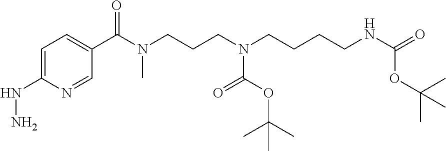 [SMILES: CN(CCCN(CCCCNC(=O)OC(C)(C)C)C(=O)OC(C)(C)C)C(=O)c1ccc(NN)nc1]

Reaction with hydrazine according to the protocols described above.

### Example 21

### Preparation of N-[3-(4-Amino-butylamino)-propyl]-6-hydrazino-N-methyl-nicotinamide, compound having formula (I) (R1=H, R2=CH₃, b=3, c=4, d=0, e=1)

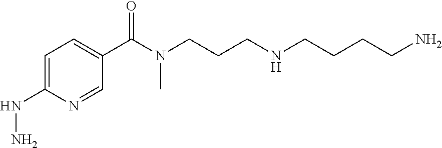 [SMILES: CN(CCCNCCCCN)C(=O)c1ccc(NN)nc1]

Deprotection with a 4 M hydrochloric acid solution in dioxane according to the protocols described above.

### Example 22

### Synthesised AADT Type Derivative

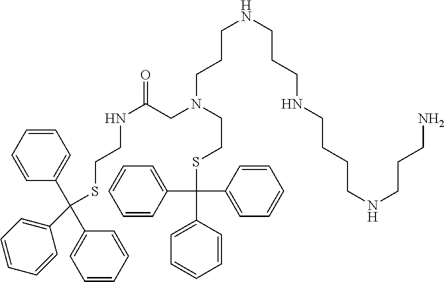 [SMILES: NCCCNCCCCNCCCNCCCN(CCSC(c1ccccc1)(c1ccccc1)c1ccccc1)CC(=O)NCCSC(c1ccccc1)(c1ccccc1)c1ccccc1]

To a mixture of 0.5 g (1 eq., 0.66 mmole) of N-[[[2-[(Triphenylmethyl) thio]ethyl]amino]carbonyl]-methyl]-N-(3′-chloropropyl)-S-(triphenylmethyl)-2-aminoethanethiol (described in J. Med. Chem. 1997, 40, 1835-1844) and 1.34 g of spermine (10 eq., 6.6 mmoles) in solution in 100 mL of 1/1 mixture of dichloromethane and methanol, 50 mg of tetrabutylammonium bromide is added. This mixture obtained is evaporated at reduced pressure to obtain an oily residue which is heated to 110° C. for 9 hours. After cooling, 50 mL of 1 N sodium hydroxide is added and extraction with dichloromethane (4×100 mL) is performed. The organic extraction phases are collected, dried on anhydrous sodium sulphate, filtered and evaporated at reduced pressure to obtain an oily residue which is purified by means of silica gel flash chromatography with a gradient ranging from 100% dichloromethane to dichloromethane/methanol/37% ammonia (70/20/10) to obtain 0.27 g (Yd: 37%) in orange oil form. Further purification by means of preparative HPLC is performed on a Waters C18-Xbridge 30×250 mm, 10 m column, flow rate 40 ml/min., I: 220 nm, mobile phase: gradient 100% acetonitrile to acetonitrile/aqueous 5 mmol HCl solution (50/50).

The fractions concerned by the product are evaporated to remove the acetonitrile and freeze-dried to obtain the product in the form of cream solid and in the hydrochloride form thereof. Yd: 12%. TLC: 4/4/2 CH₂Cl₂/methanol/ammonia: Rf: 0.5

### Example 23

### Complexing of the Compound from Example 22 with Technetium-99m

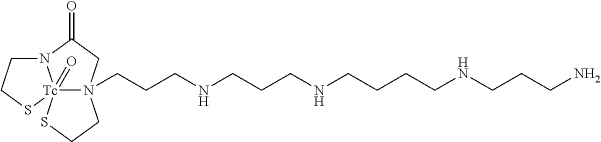

In a 100 ml flask equipped with magnetic stirring, anisole (0.2 ml; 1.8 mmol) is added to the compound from example 22 (5 mg), followed by 99% trifluoroacetic acid (10 ml; 134 mmol) giving the solution a yellow colour. The reaction medium is then stirred for 5 min at 5° C. The mixture is then titrated, drop by drop, with triethylsilane (Et₃Si) (0.07 ml; 0.43 mmol) until the yellow colour disappears. The solution is evaporated at reduced pressure at ambient temperature. The compound obtained (1 mg) is dissolved in 0.9% NaCl (1 ml) and added, in a vacuum flask, to a mixture of tin fluoride (SnF₂) (80 μg; 0.51 μmol) and ascorbic acid (0.5 mg; 2.8 μmol). The whole is then left to incubate for 3 minutes at ambient temperature, before adding sodium pertechnetate (500 μL; 185 MBq), which, reduced extemporaneously from the oxidation number +VII to the number +III, is complexed in pentadentate form. After incubating for 30 minutes, the volume is adjusted to 4 ml with 0.9% NaCl.

### Example 24

### In Vivo Studies with the Complex from Example 23

Tumour fixation: MX1 breast cancer cells (5.10⁶ cellules) were injected subcutaneously in the side of female Swiss nude mice. 22 days post-grafting, the radiolabelled probe (15 MBq5) was injected into these mice. Full-body scintigraphic images were then produced 30 min, 1 hour and 5 hours post-injection. For this, the mice, anaesthetised with isoflurane gas, were imaged in the ventral decubitus position on a gamma-camera (γ Imager, BIOSPACE Mesures) with γ Acquisition software (BIOSPACE Mesures) with the following parameters:
Spectral window: 124-160 KeV
Acquisition time: 5 min
256×256 grid

For all the images, a region of interest was plotted around the tumour and another of the same size was defined on the muscle of one back paw to determine the tumour-to-muscle ratio.

The results indicate a lack of tumour fixation, the tracer is quickly concentrated in the liver. In this way, this tracer is not recognised by the polyamine transport system.

### Example 25

### Direct chelation of Technetium-99m on spermine amines after TcO4⁻ reduction

Spermine (10 mg) is dissolved in water for injection (1 ml). 100 μL of the solution obtained is added, in a vacuum flask, to tin fluoride (80 μg; 0.51 mmol). Sodium pertechnetate is then added (370 MBq). This substance, extemporaneously reduced from the oxidation number +VII to the number +III, is then complexed in monodentate form. Ascorbic acid (0.5 mg; 2.8 μmol is then added. After incubating for 15 minutes at ambient temperature, the pH is adjusted to around 6.3-6.7.

### Example 26

### In Vivo Studies with the Compound from Example 25

Tumour fixation: B16/F10 mouse melanoma cells (2.5.10⁶ cells) were injected subcutaneously in the right back paw of male C57BL/6 mice. 10 days post-grafting, the radiolabelled probe was injected into the mice. Imaging was performed according to the protocol described in example 24 above.

The results indicate a lack of tumour fixation, some of the tracer is rapidly excreted in urine and there is a high level of liver fixation. In this way, the complex from example 25 is not recognised by the polyamine transport system.

### Example 27

### Complexing of Compounds Having Formula (I) with Technetium-99m

An example of labelling is given with N-(3-{3-[4-(3-amino-propylamino)-butylamino]-propylamino}-propyl)-6-hydrazino-nicotinamide, a compound having formula (I) (R1=R2=H, a=3, b=4, c=3, d=e=1), suitable for obtaining the following complex:

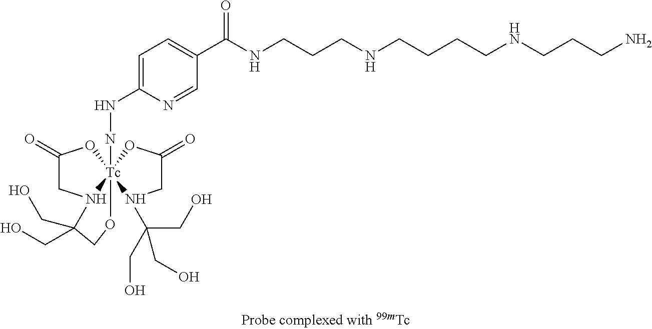

The compound having formula (I) (1.5 mg) and tricine (24 mg; 89 μmol) are dissolved in 0.9% NaCl (1.5 ml) and 1 ml of the solution obtained is placed in a vacuum flask. Tin fluoride (80 μg; 0.51 μmol) and ascorbic acid (0.5 mg; 2.8 μmol) are added as reducing agents. The whole is left to incubate for 3 minutes at ambient temperature, before adding sodium pertechnetate (500 μL; 370 MBq), which, reduced extemporaneously from the oxidation number +VII to the number +III, is then complexed in monodentate form. After incubating for 30 minutes, 10×PBS is added (0.5 ml) and the volume is adjusted to 5 ml 0.9% NaCl.

### Example 28

### Labelling Test

Reverse-phase radio-HPLC was performed on an XBridge C8 4.6*250 mm 5μ column (Waters, USA) with a mobile phase (flow rate of 1 ml/min at ambient temperature) consisting of water (55%), acetonitrile (45%) and TFA (0.1%).

No purification step was performed prior to injection.

Reverse-phase radio-HPLC analyses performed between 30 min and 5 hours post-labelling of the compounds demonstrated that the labelling is stable.

The results obtained 30 min post-labelling are shown in the table below.

| Compound having formula (II) | | | | | | Retention | Radiochemical |
|---|---|---|---|---|---|---|---|
| R2 | a | b | c | d | e | time | purity (%) |
| H⁽¹⁾ | 3 | 4 | 3 | 1 | 1 | 3 min20 | 99 |
| H | 4 | / | / | 1 | 0 | 2 min57 | 99 |
| H | 3 | 4 | 3 | 2 | 1 | 2 min46 | 98 |
| H | / | 3 | 4 | 0 | 1 | 2 min52 | 98 |
| H⁽²⁾ | 3 | 4 | 3 | 1 | 1 | 2 min33 | 99 |

| | | |
|---|---|---|
| 99mTc | 4 min41 | / |

⁽¹⁾Complex having formula (II) obtained from a compound having formula (I) wherein R1 = H.
⁽²⁾Complex having formula (II) obtained from a compound having formula (I) wherein R1 = CF₃CO.

### Example 29

### In Vitro Study—Incorporation in Various Cell Types of the Complex Having Formula (II) Obtained from a Compound Having Formula (I) Wherein R1=R2=H, a=3, b=4, c=3, d=e=1

A549 and B16 cells were placed in culture in 24-well plates (2.10⁵ cells/well). After 24 hours, the cells were incubated for 30 minutes with the complex having formula (II) at various concentrations or with 0.2 μM of complex having formula (II) optionally in the presence of an increasing concentration of spermine used for evaluating competition with the probe. After incubation, the plates were placed on ice and the cells were rinsed with cold 0.9% NaCl supplemented with 1 mM of spermidine. The cells received a treatment with trypsin. They were suspended in PBS. The activity of each well was measured using a gamma counter.

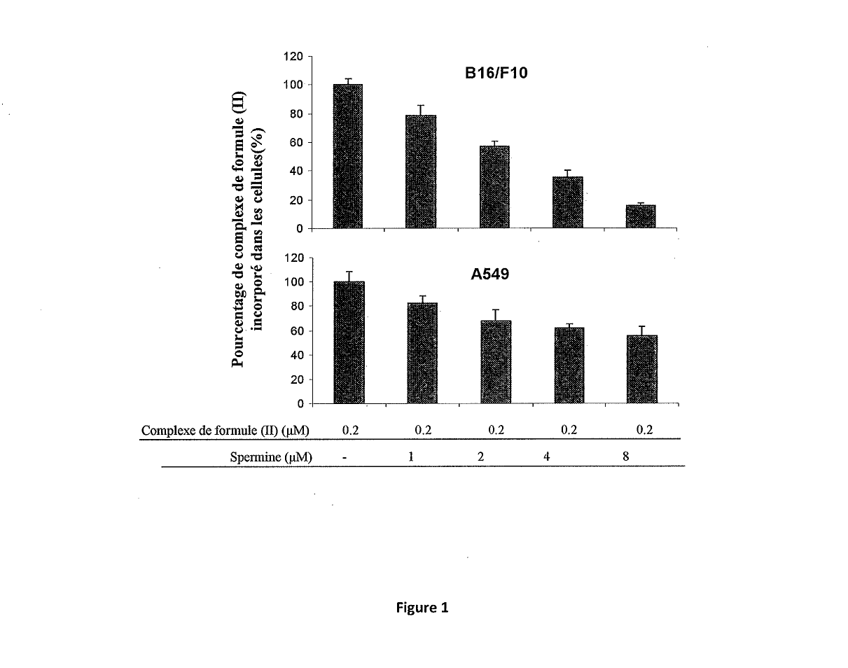

Spermine partially inhibits the incorporation of the complex having formula (II) in B16 and A549 cells (results shown in FIG. 1), indicating that the probe uses polyamine transporters to enter cells.

### Example 30

### In Vivo Studies with the Complex Having Formula (II) Obtained from a Compound Having Formula (I) Wherein R1=R2=H, a=3, b=4, c=3, d=e=1

### 1) Tumour Fixation:

B16/F10 mouse melanoma cells (2.5.10⁵ cells) were injected subcutaneously in the right back paw of male C57BL/6 mice. 10 days post-grafting, the complex having formula (II) (14.8 MBq) was injected into 18 mice, 400 μg of spermine having been previously injected into 8 of these mice. Full-body scintigraphic images were then produced 30 min and 2 hours post-injection. For this, the mice, anaesthetised with isoflurane gas, were imaged in the ventral decubitus position on a gamma-camera (γ Imager, BIOSPACE Mesures) with IRIS software (Ariès Nucléaire, France) with the following parameters:
Spectral window: 121-164 KeV
Acquisition time: 3 min
Grid: 256*256

For all the images, a region of interest was plotted around the tumour and another of the same size was defined on the muscle of the contralateral paw to determine the tumour-to-muscle ratio. The results obtained are given in the following table.

| | Post-injection time of complex having formula (II) | | | |
|---|---|---|---|---|
| | 30 min | | 2 hours | |
| | Without | With | Without | With |
| | spermine | spermine | spermine | spermine |
| Tumour-to- | 3.97 ± 1.01* | 2.31 ± 0.50 | 5.26 ± 1.40* | 2.93 ± 1.12 |
| muscle ratio | | | | |
| (mean ± | | | | |
| standard | | | | |
| deviation) | | | | |

| | | |
|---|---|---|
| Inhibition (%) | 45.0 | 47.7 |

*Significant difference (P < 0.001) between groups with or without competitor

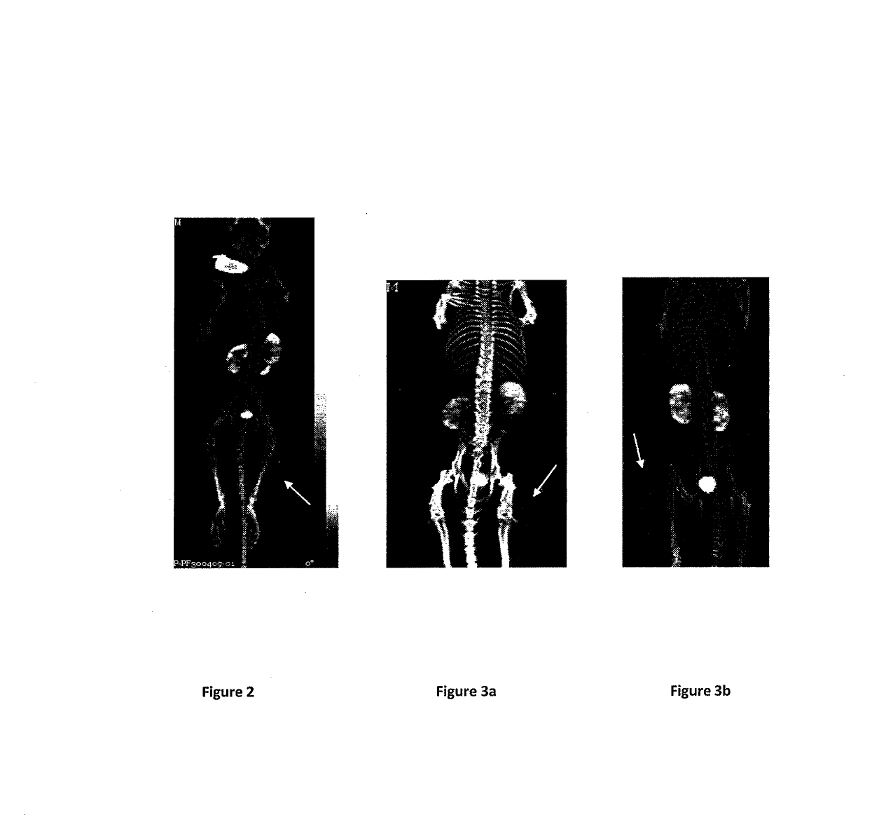

Some mice were also imaged by means of SPECT (nanoSPECT/CT, Bioscan, USA), with an image shown in FIG. 2.

The competition revealed in this study between spermine and the complex having formula (II) indicates the probe uses the polyamine transport system. This probe is thus a biomarker of the incorporation of spermine by cells.

### 2) Plasmatic Stability:

14.8 MBq of complex having formula (II) were injected intravenously to healthy male C57BL/6 mice. 30 minutes, 1 h, 2 h, 3 h and 5 hours post-injection, blood samples on heparin were taken from the retro-orbital cavity. These samples were then centrifuged for 5 minutes to collect at least 100 μL of serum. 50 enabled exclusion-diffusion radio-HPLC on a TSK SW2000 column+7.8*300 mm 5μ pre-column (Tosoh bioscience) with a mobile phase (flow rate of 1. ml/min at ambient temperature) consisting of 0.9% NaCl (100%). Macaque albumin labelled with ^{99m}Tc was used to test the albumin retention time.

The remaining 50 μL of serum was used to perform reverse-phase radio-HPLC, after protein denaturation with acetonitrile, on an XBridge C8 4.6*250 mm 5μ column (Waters, USA) with a mobile phase (flow rate of 1 ml/min at ambient temperature) consisting of water (55%), acetonitrile (45%) and TFA (0.1%).

A large proportion of the complex having formula (II) injected is eliminated rapidly (38% at 30 minutes). Some of the Technetium was trans-chelated on the plasma albumin from 30 minutes after intravenous injection. Reverse-phase radio-HPLC indicates good complex stability.

### 3) Biodistribution in Healthy Mice:

This study was conducted on 32 C57BL/6 mice (16 males and 16 females) aged 6-7 weeks. 2.96 MBq of complex having formula (II) was injected intravenously in a 60 μL volume. The animals were then sacrificed 30 min, 2 hours, 5 hours and 24 hours post-injection (4 mice/time) and various organs were removed, weighed and the activity thereof was determined with a gamma counter. The quantity of complex having formula (II) present in each organ was calculated as a percentage of the injected dose per gram of tissue (% ID)/g.

The complex having formula (II) is distributed quasi-homogeneously throughout the organs and fixation thereof only persists in the liver and kidneys. Kidney fixation is due to the megalin/cubilin system involved in a process for recovering and sparing molecules which are useful for the body. The smaller the molecules and the greater the degree of amination, the higher the recovery thereof in primary urine in the proximal tubule where uptake occurs. The fixation rates obtained in the liver and kidneys suggest that, in mice, there is no risk of renal toxicity or side-effects due to dosimetry.

### Example 31

### In Vivo Study with Other Complexes Having Formula (II)

The study was conducted according to the protocol described in example 30, 1) above with other complexes having formula (II).

The results are given in the following table:

| Complex having formula (II) | | | | | | Tumour-to- | |
|---|---|---|---|---|---|---|---|
| R2 | a | b | c | d | e | Muscle Ratio | Observations |
| H⁽¹⁾ | 3 | 4 | 3 | 1 | 1 | 5.3 ± 0.8 | Tumour fixation |
| H | 4 | / | / | 1 | 0 | 2.6 ± 1.5 | Tumour fixation |
| H | 3 | 4 | 3 | 2 | 1 | 3.2 ± 0.9 | Tumour fixation |
| H | / | 3 | 4 | 0 | 1 | 2.1 ± 0.4 | Tumour fixation |
| H⁽²⁾ | 3 | 4 | 3 | 1 | 1 | 4.6 ± 0.9 | Tumour fixation |

⁽¹⁾Complex having formula (II) obtained from a compound having formula (I) wherein R1 = H.
⁽²⁾Complex having formula (II) obtained from a compound having formula (I) wherein R1 = CF₃CO.

Some mice were also imaged by means of SPECT (nanoSPECT/CT, Bioscan, USA), with two images shown in FIGS. 3a and 3b obtained with a compound having formula (II) wherein R2=H, a=3, b=4, c=3, d=e=1, this compound having formula (II) having been obtained from a compound having formula (I) wherein R1=H or CF₃CO respectively.

It can thus be noted that all the probes bind with the tumour. However, in the case of the compounds from examples 3 and 6 (comprising less than three basic atoms in the polyamine unit), the tumour-to-muscle ratio is lower than with the other compounds, enabling lower quality tumour diagnosis.

### ABBREVIATIONS USED IN THE EXPERIMENTAL SECTION

APCI Atmospheric pressure chemical ionisation
BOC tert-Butyloxycarbonyl
TLC Thin Layer Chromatography
DMF Dimethylformamide
DMSO Dimethylsulfoxide
ESI Electrospray ionisation
HPLC High-Performance Liquid Chromatography
PBS Phosphate Buffer Saline
MP Melting point
Yd Yield
Rf Ratio-to-front
NMR Nuclear Magnetic Resonance
SPECT Single-photon emission computed tomography
TFA Trifluoroacetic acid
THF Tetrahydrofuran
Z Benzyloxycarbonyl

1.-16. (canceled)

17. A compound having the following formula (I): 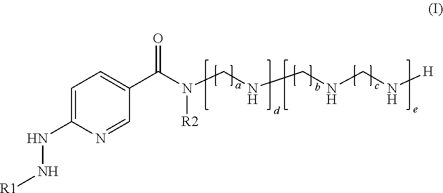
wherein:
R1 represents a hydrogen atom or an N-protecting group,
R2 represents a hydrogen atom, an optionally fluorinated or perfluorinated C₁₋₆alkyl group, or an amino-C₁₋₆alkyl group,
a, b and c represent, independently of each other, an integer from 2 to 5, and
d and e represent, independently of one another, 1 or 2,
or a pharmaceutically acceptable salt thereof.

18. The compound according to claim 17, wherein the N-protecting group is a tert-butyloxycarbonyl (tBuOCO) or trifluoroacetyl (CF₃CO) group.

19. The compound according to claim 17, wherein R2 represents a hydrogen atom or a C₁₋₆alkyl group.

20. The compound according to claim 17, wherein a, b and c represent, independently from each other, 3 or 4.

21. The compound according to claim 17, wherein e represents 1 and d represents 1 or 2.

22. The compound according to claim 17, wherein it consists of a compound having formula (I) wherein:
R1=R2=H, a=3, b=4, c=3, d=1 and e=1,
R1=R2=H, a=3, b=4, c=3, d=2 and e=1,
R1=CF₃CO, R2=H, a=3, b=4, c=3, d=1 and e=1, or
R1=tBuOCO, R2=H, a=3, b=4, c=3, d=1 and e=1,
or a pharmaceutically acceptable salt thereof.

23. A complex having the following formula (II): 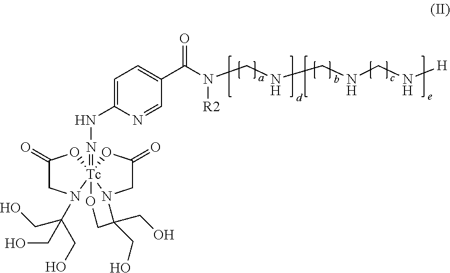
wherein:
technetium (Tc) is present in the form of the 99m isotope thereof,
R2 represents a hydrogen atom, an optionally fluorinated or perfluorinated C₁₋₆alkyl group, or an amino-C₁₋₆alkyl group,
a, b and c represent, independently of each other, an integer from 2 to 5, and
d and e represent, independently of one another, 1 or 2,
or a pharmaceutically acceptable salt thereof.

24. The complex according to claim 23, wherein R2 represents a hydrogen atom or a C₁₋₆alkyl group.

25. The complex according to claim 23, wherein a, b and c represent, independently from each other, 3 or 4.

26. The complex according to claim 23, wherein e represents 1 and d represents 1 or 2.

27. The complex according to claim 23, wherein it consists of a complex having formula (II) wherein:
R2=H, a=3, b=4, c=3, d=1 and e=1, or
R2=H, a=3, b=4, c=3, d=2 and e=1,
or a pharmaceutically acceptable salt thereof.

28. A method for detecting in vivo a cancer tumour expressing the polyamine transport system comprising administering an effective amount of a complex having formula (II) according to claim 23 or a pharmaceutically acceptable salt thereof to a person in need thereof.

29. The method according to claim 28, comprising a step of detecting the radioactivity emitted by Technetium-99m comprised in the complex having formula (II) by scintigraphic imaging.

30. A method for detecting in vitro a cancer tumour expressing the polyamine transport system comprising administering an effective amount of a complex having formula (II) according to claim 23 or a pharmaceutically acceptable salt thereof in vitro.

31. The method according to claim 30, comprising a step of detecting the radioactivity emitted by Technetium-99m comprised in the complex having formula (II).

32. A composition comprising at least one compound having formula (I) according to claim 17 or a pharmaceutically acceptable salt thereof and at least one pharmaceutically acceptable excipient.

33. A diagnostic composition comprising at least one complex having formula (II) according to claim 23 or a pharmaceutically acceptable salt thereof and at least one pharmaceutically acceptable excipient.

34. A kit comprising:
(1) a composition as defined in claim 32,
(2) tricine, and
(3) a reducing agent.

35. The kit according to claim 34, wherein the reducing agent is a mixture of tin fluoride and ascorbic acid.

36. A process for preparing a diagnostic composition according to claim 33 comprising the mixture of a composition comprising at least one compound having formula (I): 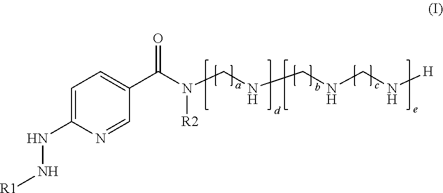
wherein:
R1 represents a hydrogen atom or an N-protecting group,
R2 represents a hydrogen atom, an optionally fluorinated or perfluorinated C₁₋₆alkyl group, or an amino-C₁₋₆alkyl group,
a, b and c represent, independently of each other, an integer from 2 to 5, and d and e represent, independently of one another, 1 or 2,
a pharmaceutically acceptable salt thereof and at least one pharmaceutically acceptable excipient with a pertechnetate-99m salt, at least one reducing agent and tricine.

37. The process according to claim 36, wherein the reducing agent is a mixture of tin fluoride and ascorbic acid.

38. A process for preparing a compound having formula (I) according to claim 17 or a pharmaceutically acceptable salt thereof comprising the following successive steps:
(a) reacting 6-halo-nicotinic acid with a protected polyamine having the following formula (III): 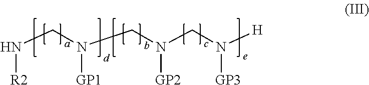
wherein:
R2 represents a hydrogen atom, an optionally fluorinated or perfluorinated C₁₋₆alkyl group, or an amino-C₁₋₆alkyl group,
a, b and c represent, independently of each other, an integer from 2 to 5,
d and e represent, independently of one another, 1 or 2, and
GP1, GP2 and GP3, identical or different, each represent an N-protecting group, to obtain a compound having the following formula (IV): 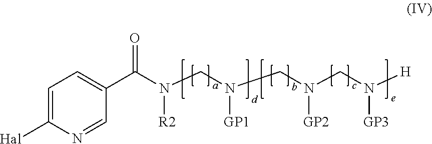
wherein R2, a, b, c, d, e, GP1, GP2 and GP3 are as defined above and Hal represents a halogen atom,
(b) reacting the compound having formula (IV) obtained in step (a) above with hydrazine to obtain a compound having the following formula (V): 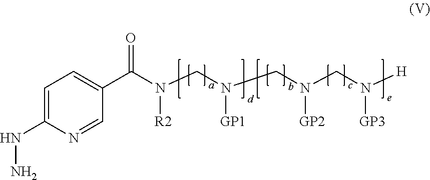
wherein R2, a, b, c, d, e, GP1, GP2 and GP3 are as defined above,
(c) optionally protecting, with an N-protecting group, the hydrazine function of the compound having formula (V) obtained in step (b) above to obtain a compound having the following formula (VI): 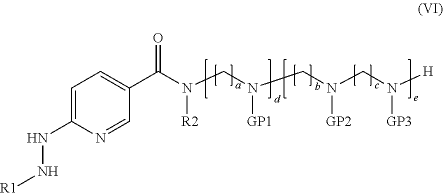
wherein R2, a, b, c, d, e, GP1, GP2 and GP3 are as defined above and R1 represents an N-protecting group,
(d) deprotecting the amine functions protected by the groups GP1, GP2 and GP3 in the compound having formula (V) or (VI) obtained in step (b) or (c) above to obtain a compound having formula (I),
(e) optionally salifying the compound having formula (I) obtained in step (d) above to obtain a pharmaceutically acceptable salt thereof, and
(f) separating the compound having formula (I) or the pharmaceutically acceptable salt thereof obtained in the previous step from the reaction medium.

39. A process for preparing a compound having formula (I) according to claim 17 wherein R1≠H or a pharmaceutically acceptable salt thereof comprising the following successive steps:
(i) protecting, with an N-protecting group, the hydrazine function of 6-hydrazinyl-nicotinic acid to obtain a compound having the following formula (VII): 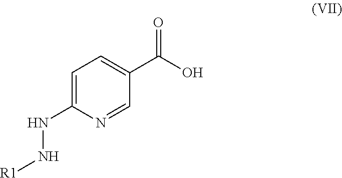
wherein R1 represents an N-protecting group,
(ii) reacting the compound having formula (VII) obtained in step (i) above with a protected polyamine having the following formula (III): 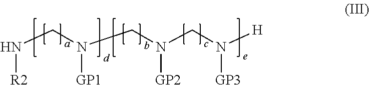
wherein:
R2 represents a hydrogen atom, an optionally fluorinated or perfluorinated C₁₋₆alkyl group, or an amino-C₁₋₆alkyl group,
a, b and c represent, independently of each other, an integer from 2 to 5,
d and e represent, independently of one another, 1 or 2, and GP1, GP2 and GP3, identical or different, each represent an N-protecting group, to obtain a compound having the following formula (VI): 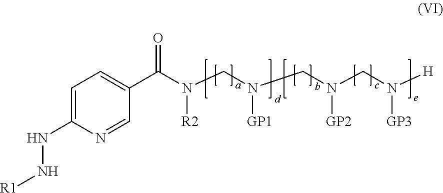
wherein R1, R2, a, b, c, d, e, GP1, GP2 and GP3 are as defined above,
(iii) deprotecting the amine functions protected by the groups GP1, GP2 and GP3 in the compound having formula (VI) obtained in step (ii) above to obtain a compound having formula (I) wherein R1≠H,
(iv) optionally salifying the compound having formula (I) obtained in step (iii) above to obtain a pharmaceutically acceptable salt thereof, and
(v) separating the compound having formula (I) or the pharmaceutically acceptable salt thereof obtained in the previous step from the reaction medium.

40. A process for preparing a complex having formula (II) according to claim 23 or a pharmaceutically acceptable salt thereof comprising the mixture of a compound having formula (I): 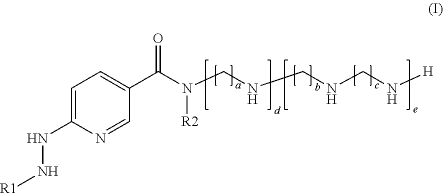
wherein:
R1 represents a hydrogen atom or an N-protecting group,
R2 represents a hydrogen atom, an optionally fluorinated or perfluorinated C₁₋₆alkyl group, or an amino-C₁₋₆alkyl group,
a, b and c represent, independently of each other, an integer from 2 to 5, and
d and e represent, independently of one another, 1 or 2,
or a pharmaceutically acceptable salt thereof, with a pertechnetate-99m salt, at least one reducing agent and tricine.

41. The process according to claim 40, wherein the reducing agent is a mixture of tin fluoride and ascorbic acid.
